(19) United States
(12) Patent Application Publication
(10) Pub. No.: US 2024/0020498 A1
(43) Pub. Date: Jan. 18, 2024

(54) CODE READING DEVICE AND DISPLAYING A FOCUS SETTING

(71) Applicant: SICK AG, Waldkirch (DE)

(72) Inventors: Christopher WEBER, Waldkirch (DE); Frank SCHÜTZ, Waldkirch (DE)

(21) Appl. No.: 18/222,628

(22) Filed: Jul. 17, 2023

(30) Foreign Application Priority Data
Jul. 18, 2022 (EP) 22185480.5

(51) Int. Cl. G06K 7/14; G06K 7/10

(52) U.S. Cl. CPC G06K 7/1447; G06K 7/10811

(57) ABSTRACT

A code reading device (10) for reading optical codes (48) is provided that has a light reception element (18) for detecting image data having an optical code (48), an optics (16), a focus adjustment unit (17) for setting a focal position of the optics (16), a display device (24) for optical and/or acoustic feedback on the focus setting, and a control and evaluation unit (34) that is configured to read the code (48) using a decoding method by evaluating the image data, The control and evaluation unit (34) is furthermore configured to evaluate a quality of a currently set focal position and to provide feedback on the quality via the display device.

The invention relates to a code reading device for reading optical codes and to a method of displaying a focus setting respectively.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera based code reader records images of the objects having the codes located thereon by means of an image sensor and image evaluation software extracts the code information from these images. Camera based code readers also cope without problem with different code types than one-dimensional barcodes which also have a two-dimensional structure like a matrix code and provide more information.

In an important application group, the objects bearing the code are conveyed past the code reader. A code scanner here detects the respective codes successively led into its reading zone. Alternatively, in a camera based code reader, a line scan camera reads in the object images having the code information successively and linewise with the relative movement. As a rule, image data are recorded using a two-dimensional image sensor that overlap more or less depending on the recording frequency and on the conveying speed. So that the objects can be arranged in any desired orientation on the conveyor, a plurality of code readers are often provided at a reading tunnel to record objects from a plurality of sides or from all sides.

A code reader is typically equipped with a focus adjustable optics. An optimum work point is set by it in which the codes are recorded in focus and are thus read at a high reading rate. It has long been known to focus on the respective object in a situation dependent manner using an autofocus function. There are, however, additionally a large number of applications in which devices are used that dispense with an autofocus to save costs, due to a small size, or to avoid mechanical wear for continuous focus adjustments. A manual focus adjustment, for instance by turning a focusing ring on the objective, then enables the focusing on a typical application situation, with the depth of field range of the code reader being sufficient to continue to be able to read codes at distances differing therefrom. A graphical user interface on an installation machine serves to check whether the focal position has been correctly set for the typical application situation, for example when recording a sample object. The focusing ring is turned to the left and right for so long until the operator has found the point of maximum image sharpness.

In the field, however, code readers are often installed at positions of a reading tunnel, for example, that are unfavorable for the operator. The operator has to adopt an unfavorable posture and climb onto the conveyor belt or onto a ladder, for example, to reach the device and affect its focal position manually. The installation machine with a display of a focal status here then only remains in the field of view, if at all, with difficulty. The consequence is an extremely laborious setting up procedure with a plurality of changes of location between the device and the installation machine or dangerous postures to obtain a view of the installation machine. This gives rise to the temptation only to set the focal position half-heartedly so that the device does not display its optimum performance and the reading rate deteriorates.

EP 2 136 248 A1 discloses an image capturing device with adaptable illumination, namely object illumination and/or positioning illumination. An adjustment of the focusing of the reception optics automatically effects the adaptation of the object and/or positioning illumination to the adjusted focus. WO 2009/007772 A2 deals with a camera system that projects a luminous reference figure onto the detecting plane, with the focusing of the camera and of the reference figure corresponding to one another. An indication of the current focal setting admittedly thereby respectively results, but this is difficult to evaluate from an installation position and there is no direct support to find an optimum focal position.

An auxiliary system for focusing a web camera (webcam) is known from DE 20 2013 102 193 U1. A focus algorithm is carried out using image data statistics and an acoustic or optical signal generator is then controlled so that a user can set the lens manually. A red display lamp on the device flashes continuously for this purpose and a buzzer buzzes constantly when the recording image is in blurred state. When a focused state is approached, the red display lamp is extinguished and a green display lamp flashes continuously while the buzzer does not emit a buzzing sound. The green display lamp lights up continuously in a focused state. Feedback via display lamps on the device is completely acceptable for a webcam, but is very frequently not useful for a code reader in the described installation situation at a reading tunnel because the display lamps are no longer visible in the installation position.

It is therefore the object of the invention to simplify and improve the setting up of a code reading device.

This object is satisfied by a code reading device for reading an optical code and by a method of displaying a focus setting in accordance with the respective independent claim. The code reading device can be a barcode scanner, for example with a photodiode as a light reception element. A brightness profile recorded during the scanning then delivers image data corresponding to a image line. It is preferably a camera based code reader with an image sensor as the light reception element. This image sensor can in turn be a line sensor for detecting a code line or an areal code image by assembling image lines in the course of a relative movement between a code reading device and an optical code. It is alternatively a matrix sensor, with recordings of a matrix sensor also being able to be assembled into a larger starting image. A network of a plurality of code readers or camera heads is likewise conceivable.

The code reading device has an optics. A reception optics or a reception objective of a camera based code reader is preferably thought of by this that has one or more lenses and other optical elements depending on the quality demands and provides the recording of high quality images. The optics can focus the scanning beam and thus the scanning light spot at the transmission side in a barcode scanner. A focus adjustment of the optics is provided for a respective adaptation of the focal position. The focus adjustment preferably takes place manually and not by autofocus. In addition to a preferred purely mechanical focus adjustment, for example by means of a setting ring, a motorized focus adjustment is possible that is operated manually.

The code reading device furthermore has display means for optical and/or acoustic feedback on the focus adjustment. A control and evaluation unit that can be integrated in the code reading device or that can be connected thereto as a control unit evaluates the image data and reads the code using a decoding method.

The invention starts from the basic idea of evaluating the currently set focal position and reporting a result of this evaluation back to the user. The feedback via the display device comprises information on quality corresponding to the focus.

The invention has the advantage that feedback on the current focal position is given to the operator in a particularly simple and ergonomic form. A visualization on an installation machine is no longer necessary. The difficulty of keeping the installation machine in sight in installation positions that are difficult to access is thus dispensed with. The putting into operation becomes simpler, faster, and produces better results from which the later reading rate profits.

The control and evaluation unit is preferably configured to evaluate the quality of the focal position by means of an image evaluation of the image data. The control and evaluation unit here automatically subjects the image data recorded in the current focal position to an image processing by which the focus can be evaluated, for example by a contrast measurement.

The code reading device preferably has a distance sensor, with the control and evaluation unit being configured to evaluate the quality of the focal position using a distance value of the distance sensor. The distance sensor measures the distance from the recorded object and this distance value indicates the optimum focal position. In contrast to an autofocus system, however, no automatic control loop is set up; the distance measurement is rather used to support the operator.

The control and evaluation unit is preferably configured to compare the quality of the currently set focal position with a previously set focal position. This comparison can take place at the level of the respective quality, of the measured distances, and/or of the image data themselves. The comparison provides a conclusion on what influence last performed focus adjustments have had on the quality. More direct feedback on the direction or the extent of focus adjustments still required are thereby possible.

The control and evaluation unit is preferably configured to display a quantitative deviation with respect to an optimum focal position by the feedback. The feedback thus goes beyond a qualitative display that the focal position is not yet optimum; it provides quantitative information on a deviation that is still present. The display can, for example, be a percentage, with this not necessarily being displayed in numerals, but in any desired suitable representation. In another respect, display means that the abilities of the display device are used and thus excludes an acoustic display.

The control and evaluation unit is preferably configured to display a direction for a still required focus adjustment by the feedback to achieve an optimum focal position. The feedback thus includes information on whether the instantaneously set focal position has been set too short or too long with respect to the optimum focal position. The still required further manual focus adjustment that can be derived therefrom is of interest for the user. An arrow can, for example, require a turning of an adjustment ring counter clockwise so that the direction of the optimum focal position is shown at least implicitly. The most varied representations of this information, including an acoustic display, are again possible.

The display device is preferably configured to project a light signal or a light pattern onto the optical code or onto an object having the code. The projection has the advantage that the feedback becomes more easily accessible. The code reading device necessarily has to have free sight of the code irrespective of how unfavorable the installation position may otherwise be so that an operator who carries out settings at the device can likewise as a rule easily see the code and a light signal or light pattern projected thereon. This is by no means the case with a display directly on the device itself that would frequently be covered in the installation position.

The display device is preferably configured as a sighting mechanism to align the code reading device. Such a sighting mechanism is present in many code reading devices to find a reading or installation position in which a code can be easily recorded. Where the code reading device expects the code to be read can be recognized by visual feedback, for instance a target cross. A code reader installed in a reading tunnel is, for example, aligned onto a sample object or in a presentation application provides that the code is located more or less centrally in the reading field. Such a sighting mechanism can now additionally be used in a dual function as a display device in accordance with the invention.

The control and evaluation unit is preferably configured to display feedback on the quality of the currently set focal position, a deviation from an optimum focal position, a direction and/or a degree of a focus adjustment required to achieve an optimum focal position via a flashing sequence, a light pattern, a color, a brightness, a pitch, a sound sequence, and/or a volume. In accordance with the invention, differentiated feedback on the focal position and a focus adjustment still required for an optimum image recording can be given by a correspondingly configured display device. A projection onto the code as explained in the two preceding paragraphs is particularly suitable for this since a light signal or a light pattern has a large number of parameters for intuitive displays via the spatial arrangement, its time behavior, its color, and its brightness. Flashing sequences, symbol images for different focus qualities, direction arrows for still required focus adjustments and the like can be used, for example. All this is equally conceivable on a display on the device itself, in particular complementary to a projection. Similar concepts are implementable acoustically via sound sequences, melodies, or jingles, and the volume, in particular complementarily to an optical display.

The control and evaluation unit is preferably configured to display a faster or slower flashing sequence and/or sound sequence, up to a permanent light and/or a permanent sound on a reaching of an optimum focal position, depending on the degree of a deviation from an optimum focal position. This is a particularly advantageous example from the just presented variety of possible displays to communicate the still required steps for reaching an optimum focal position in a manner that is detectable as simply as possible and intuitively.

The code reading device is preferably installed in a stationary manner at a conveying device that leads objects having codes to be detected in a conveying direction through a detection zone. This is a particularly frequent application situation and the unfavorable installation positions for the operator in particular frequently occur here. The feedback in accordance with the invention on the quality of the current focal position and the support in finding the still required focus adjustment are particularly helpful here.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

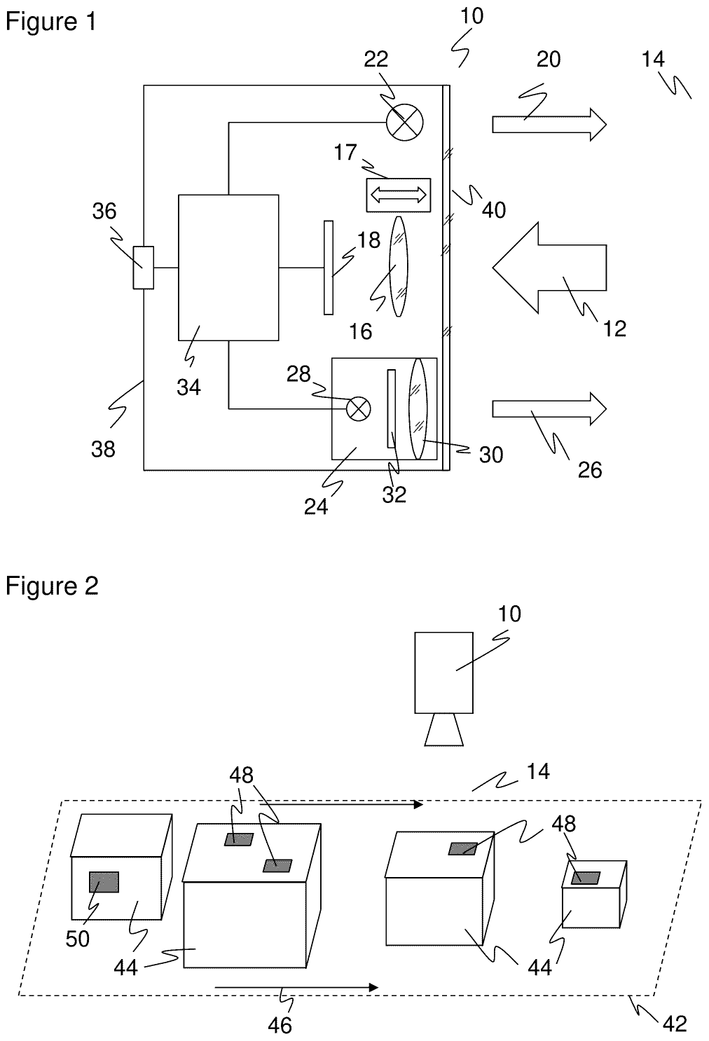

FIG. 1 a schematic sectional representation of a code reading device;

FIG. 2 an exemplary installation of a code reading apparatus at a conveying device; and

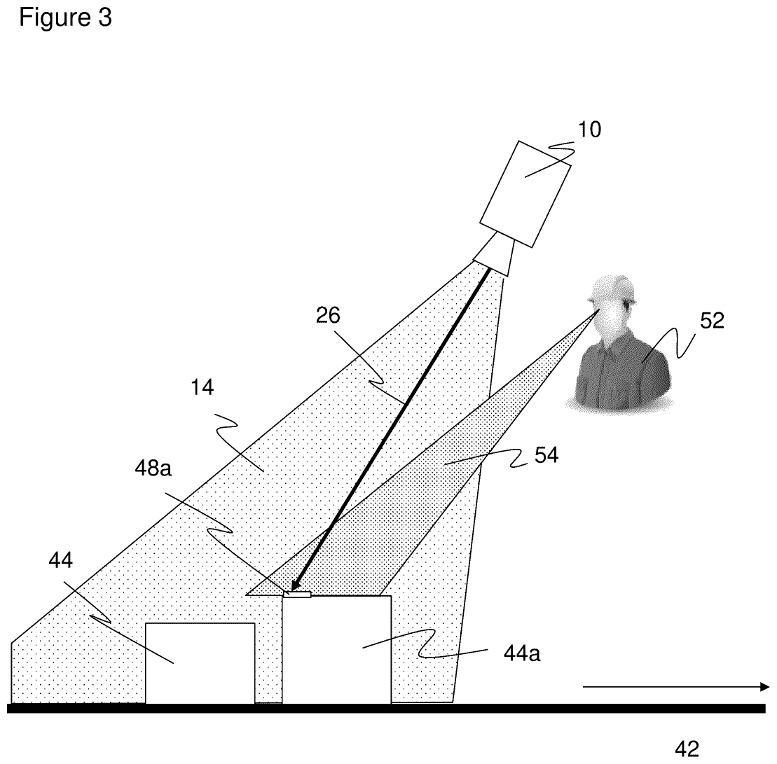

FIG. 3 a sketch to illustrate feedback on a set or still to be set focal position of a code reading device to an operator.

FIG. 1 shows a schematic sectional representation of a code reading device Received light 12 from a detection zone 14 is incident on a reception optics 16 that conducts the received light 12 to an image sensor 18. The optical elements of the reception optics 16 are preferably configured as an objective composed of a plurality of lenses and other optical elements such as diaphragms, prisms, and the like, but here only represented by a lens for reasons of simplicity. The reception optics 16 can be set to different focal positions by means of a focus adjustment 17 to record objects in focus at different distances. The most varied functional principles are conceivable for this purpose, for example an adjustment ring at the reception optics 16 or an inner contour that has been made accessible for a tool from the outside to turn a thread, as described in DE 10 2018 102 917 B3.

To illuminate the detection zone 14 with transmitted light 20 during a recording of the code reading device 10, the code reading device 10 comprises an optional illumination unit 22 that is shown in FIG. 1 in the form of a simple light source and without a transmission optics. In other embodiments, a plurality of light sources such as LEDs or laser diodes are arranged around the reception path, in ring form, for example, and can also be multi-color and controllable in groups or individually to adapt parameters of the illumination unit 22 such as its color, intensity, and direction.

The code reading device 10 furthermore has a display device 24 by which feedback on a set focal position can be output. In the embodiment shown, the display takes place by projection 26 into the detection zone 14. The display device 24 has a light source 28, for example with one or more lasers or LEDs, and a projection optics 30 for the projection 26. In some embodiments, the light source itself is simply projected. For more complex light patterns, an optional pattern generation element 32 can be provided that can be switchable in a particularly advantageous manner to generate different light patterns. Different light signals and light patterns can thus be displayed that are variable in their shapes, time sequences, colors, and brightnesses in dependence on the embodiment. In other embodiments, a display is possible directly on the device or an acoustic display is possible, with them all also being combinable with one another. The acoustic display can enable the output of simple sounds, but also of sound sequences or melodies or jingles in different timbres and volumes.

A control and evaluation unit 34 is connected to the image sensor 18, the illumination unit 22, and the display device 24 and is responsible for the control work, evaluation work, and other coordination work in the code reading device 10. It sets a suitable illumination, records images, reads out image data of the image sensor, and decodes codes in the image data. For this purpose, a segmentation preferably takes place in a manner known per se to locate code zones and the code zones are supplied to at least one decoder. Read codes, optionally also the image data themselves, can be stored or can be output at an interface 36. A plurality of modules can be provided for the different control and evaluation work, for example to perform pre-processing of the image data on a separate FPGA.

The display device 24 is controlled during the putting into operation to give feedback on the current focal position. It can be coupled to a target display by which an operator recognizes where the detection zone 14 is located. The control and evaluation unit 34 subjects the currently recorded image data to image processing to judge the image focus and thus to evaluate the quality of the instantaneously set focal position. Alternatively or additionally, the distance from a recorded object and thus code can be measured by a distance sensor, not shown, and the optimum focal position can be determined from the distance value.

The code reading device 10 is protected by a housing 38 that is terminated by a front screen 40 in the front region where the received light 12 is incident. The assembly shown is to be understood purely by way of example. Alternatively to a camera based code reading device 10, a barcode scanner is conceivable that uses a focus adjustable optic to bundle its scanning beam at the reading distance.

FIG. 2 shows a possible use of the code reading device 10 in an installation at a conveyor belt 42. The code reading device 10 is shown here only as a symbol and no longer with its structure already explained with reference to FIG. 1. The conveyor belt 42 conveys objects 44, as indicated by the arrow 46, through the detection zone 14 of the code reading device 10. The objects 44 bear code zones 48 at their outer surfaces. It is the object of the code reading device 10 to recognize code zones 48 and to read the codes affixed there, to decode them, and to associate them with the respective associated object 44. In order also to detect laterally applied code zones 50, additional code reading devices 10, not shown, are preferably used from different perspectives. In addition, a plurality of code reading devices 10 can be arranged next to one another to together cover a wider detection zone 14.

FIG. 3 shows a sketch to illustrate of the feedback on a set or still to be set focal position of the code reading device 10 to an operator by means of the display device 24. A specific object 44a is targeted, preferably in the image center, during the putting into operation, with it in particular being a reference object having a known code 48a. The display device 24 in this embodiment simultaneously acts by way of example as a sighting mechanism that marks the detection zone 14, in particular over its center, via its projection 26. The projection 26 must anyway be easily visible for the putting into operation; such a dual function is therefore not only of advantage from an apparatus aspect, but also functionally.

The operator 52 has a perspective 54 that is similar to that of the code reading device 10 or the detection zone 14 since the operator 52 has to be located in the direct proximity of the code reading device 10 for the assembly and setting. The projection 26 is therefore easily recognizable on the code 48a. The control and evaluation unit 34 can thereby effectively provide information on the instantaneous focal position or on still required focus adjustments to the operator 52.

A defined flashing pattern that is imparted onto a simple light spot or onto a more complex light pattern can be named as a particularly advantageous example among the large number of possible light patterns, time sequences, color and brightness properties of the projection 26 for feedback. A permanent display without flashing can serve as a sign that the optimum focal position with a working point of maximum image focus has been found. The laser flashes in more blurred focal positions, with the flashing frequency being small at greater blur and approaching the permanent light due to a higher flashing frequency with improved focus. The operator 52 is thereby aware of the correct direction for further focus adjustments intuitively and in a very fast detectable manner and knows when the aim of an optimum focal position has been reached. In parallel with or alternatively to this, the display device 24 can output a signal sound having the described repetition rate by means of integrated or external loudspeakers.

1. A code reading device for reading optical codes that has a light reception element for detecting image data having an optical code, an optics, a focus adjustment unit for setting a focal position of the optics, a display device for optical and/or acoustic feedback on the focus setting, and a control and evaluation unit that is configured to read the code using a decoding method by evaluating the image data,
wherein the control and evaluation unit is furthermore configured to evaluate a quality of a currently set focal position and to provide feedback on the quality via the display device.

2. The code reading device in accordance with claim 1,
wherein the control and evaluation unit is configured to evaluate the quality of the focal position by means of image evaluation of the image data.

3. The code reading device in accordance with claim 1,
that has a distance sensor, with the control and evaluation unit being configured to evaluate the quality of the focal position using a distance value of the distance sensor.

4. The code reading device in accordance with claim 1,
wherein the control and evaluation unit is configured to compare the quality of the currently set focal position with a previously set focal position.

5. The code reading device in accordance with claim 1,
wherein the control and evaluation unit is configured to display a quantitative deviation with respect to an optimum focal position by the feedback.

6. The code reading device in accordance with claim 1,
wherein the control and evaluation unit is configured to display a direction for a still required focus adjustment by the feedback to achieve an optimum focal position.

7. The code reading device in accordance with claim 1,
wherein the display device is configured to project a light signal or a light pattern onto the optical code or onto an object having the code.

8. The code reading device in accordance with claim 7,
wherein the display device is configured as a sighting mechanism to align the code reading device.

9. The code reading device in accordance with claim 1,
wherein the control and evaluation unit is configured to display feedback on the quality of the currently set focal position, a deviation from an optimum focal position, a direction and/or a degree of a focus adjustment required to achieve an optimum focal position via a flashing sequence, a light pattern, a color, a brightness, a pitch, a sound sequence, and/or a volume.

10. The code reading device in accordance with claim 9,
wherein the control and evaluation unit is configured to display a faster or slower flashing sequence and/or sound sequence, up to a permanent light and/or a permanent sound on a reaching of an optimum focal position it, depending on the degree of a deviation from an optimum focal position.

11. The code reading device in accordance with claim 1,
that is installed in a stationary manner at a conveying device that guides objects having codes to be detected in a direction of conveying through a detection zone of the code reading device.

12. A computer implemented method of displaying a focus setting of a code reading device for reading optical codes, that has a light reception element for detecting image data having an optical code, an optics, a focus adjustment unit for setting a focal position of the optics, and a display device for optical and/or acoustic feedback on the focus setting, characterized in that
a quality of a currently set focal position is evaluated and feedback on the quality is given via the display device.

13. The method in accordance with claim 12, wherein the code reading device further has a control and evaluation unit that is configured to read the code using a decoding method by evaluating the image data,
wherein the control and evaluation unit is furthermore configured to evaluate the quality of a currently set focal position and to provide the feedback on the quality via the display device.
